(19) United States
(12) Patent Application Publication
(10) Pub. No.: US 2008/0053485 A1
(43) Pub. Date: Mar. 6, 2008

(54) Method for cleaning and drying substrate

(76) Inventors: Takayuki Yanase, Toyama (JP); Yasuyuki Deguchi, Toyama (JP); Takeshi Uragami, Toyama (JP); Akihiko Komori, Toyama (JP)

Correspondence Address: MCDERMOTT WILL & EMERY LLP, 600 13TH STREET, NW, WASHINGTON, DC, 20005-3096, US

(21) Appl. No.: 11/878,839

(22) Filed: Jul. 27, 2007

(30) Foreign Application Priority Data
Aug. 29, 2006 (JP) 2006-231558

(51) Int. Cl. B08B 3/08

(52) U.S. Cl. 134/26

(57) ABSTRACT

A method for cleaning and drying a substrate in order to restrain formation of minute defects on a substrate surface when the substrate is dried by supplying the vapor of an organic solvent such as IPA. The method comprises the steps of: rinsing a surface of the substrate in a rising bath with pure water after wet processing of the substrate surface with liquid chemicals; lifting the substrate from the rinsing bath at a speed determined in advance by making a substrate surface hydrophobic, after rinsing the substrate; and removing moisture from the substrate surface by supplying an organic solvent to the substrate for a specified time, after lifting the substrate, the organic solvent being water soluble and lowering surface tension of the pure water.

### FIELD OF THE INVENTION

The present invention relates to a method for drying an object to be cleaned. More particularly, this invention relates to the method suitable for cleaning, rinsing and drying a substrate such as a semiconductor wafer.

### BACKGROUND OF THE INVENTION

Conventionally, in the method for cleaning and drying the wafer after the process with liquid chemicals, use is made of a single-bath type wet processing apparatus having a drying function using an organic solvent, such as IPA alleged to be effective for reduction of particles and watermarks, as described in Japanese Patent Application Publication Laid-Open No. 2003-257916, for example. In this single-bath type wet processing apparatus, as shown in FIG. 1, a rinsing bath 101 with pure water is formed together with a drying bath 102 using an organic solvent.

In cleaning and drying processing with this apparatus, an object to be cleaned (wafer) 301 is cleaned in the lower pure water rinsing bath 101 by delivering pure water from a nozzle 205 for a specified period of time. After that, the wafer is lifted to a predetermined position at a constant speed (approximately 5 to 10 mm/sec), while the wafer is supported by wafer supporting members 204. A mist is generated from a room-temperature or heated organic solvent using inert gas (mainly N2) as a carrier and is supplied to the wafer surface via a mist-straightening vane 201. Subsequently, the moisture on the wafer is replaced with the organic solvent. Further, the moisture is easily released from the wafer surface because the surface tension of the moisture is lowered due to the organic solvent. Next, the pure water in the rinsing bath 101 is drained from a drain outlet 206 and air is further exhausted from an exhaust nozzle 203. Simultaneously, the heated or room-temperature inert gas (mainly N2) is supplied onto the wafer from the nozzle 202 and the organic solvent on the wafer is removed. In the apparatus, the organic solvent mist is supplied after the wafer is lifted, and there is no drying due to the Marangoni effect.

### SUMMARY OF THE INVENTION

However, with the method, when the wafer surface is hydrophobic, streak- or strip-shaped minute defects formed from particles and/or watermarks may be generated on the wafer after the cleaning and drying process. These defects are generated due to beads of excess moisture remaining in streaks on the wafer during the wafer moving from the pure water rising bath into the inert gas atmosphere (mainly nitrogen).

Taking these circumstances into consideration, the objective of the present invention is to prevent excess moisture from remaining in streaks on the substrate by controlling lifting speed to move the wafer from the pure water interface in the pure water rinsing bath into the inert gas atmosphere, and thereby to prevent the generation of minute defects formed from particles, watermarks, and the like.

In order to accomplish the objective, the present invention provides a method for cleaning and drying a substrate. In the method, when the substrate is lifted from a rinsing bath, the lifting speed is controlled at the speed determined with a substance surface hydrophobic in advance, for example, at a finite value of 2 mm/sec or lower, during the period from the time when the upper end of wafer is exposed from the water surface until the time when the entire surface of the wafer is almost or completely exposed. The controlling of the lifting speed restrains the generation of minute defects in lengthwise streak or strip shape on the substrate from particles, watermarks, and the like, even if the substrate to be dried has the hydrophobic surface.

The method of the present invention prevents moisture from remaining in streaks on the substrate having the hydrophobic surface. As a result, the method prevents the generation of minute defects formed from particles and watermarks onto the substrate surface.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a cross section of a single-bath type wet processing apparatus used for the method for cleaning and drying a substrate according to the embodiment of the present invention.

FIG. 2 is a graph showing a relationship between the substrate lifting speed and the increased number of minute defects that are detected on the wafer having a complete hydrophobic surface.

FIG. 3 is a diagram showing a mechanism where excess moisture remains on a wafer.

### DETAILED DESCRIPTION OF THE INVENTION

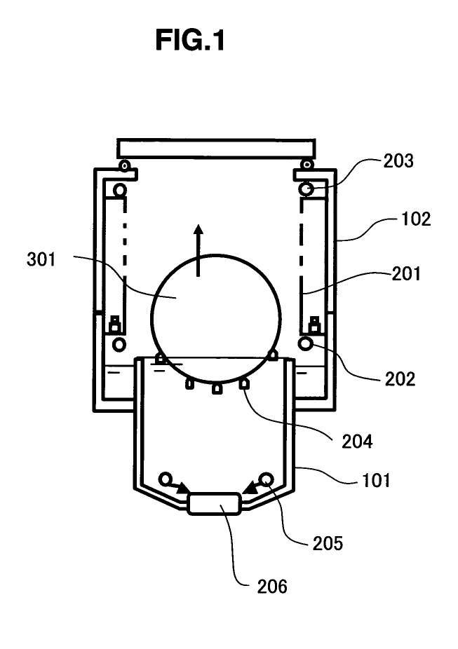

With the method for cleaning and drying a substrate according to the embodiment of the present invention, the substrate can be cleaned and dried using the single-bath type wet processing apparatus, as shown in FIG. 1.

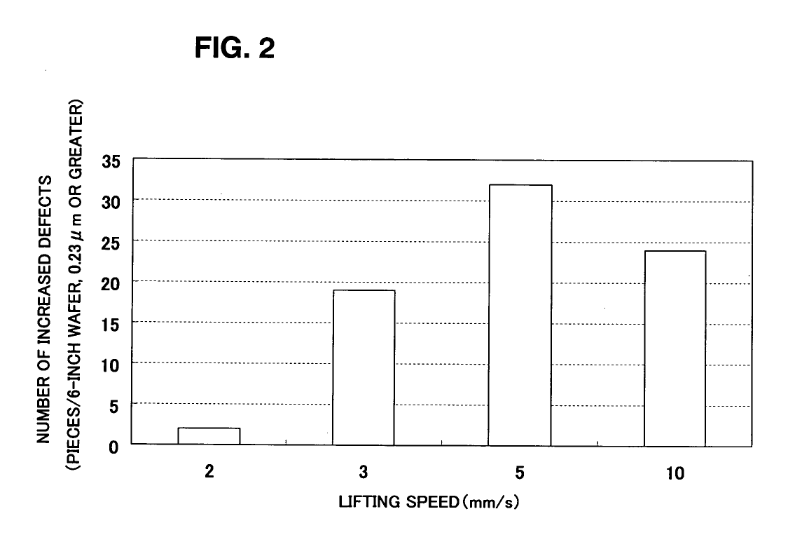

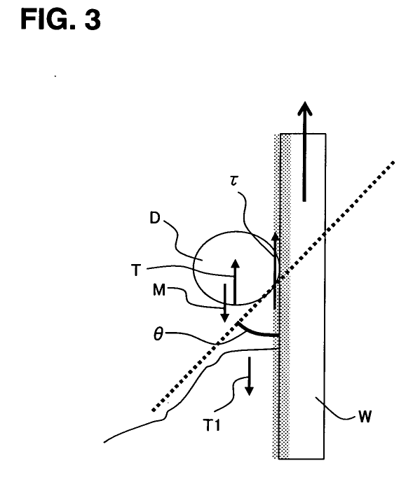

An example is described hereafter where when a wafer has a hydrophobic surface by processing the wafer substrate with a hydrofluoric acid solution, the wafer lifting speed from the pure water rinsing bath is controlled so that the number of minute defects formed from particles and watermarks to be generated on the wafer is reduced, with reference to FIG. 2 and FIG. 3.

FIG. 2 shows the results of measuring the number of increased minute defects detected after the cleaning and drying process with the single-bath type apparatus using an organic solvent that is water soluble and lowers the surface tension of pure water, such as IPA, after the wafer is processed into a complete hydrophobic state using a hydrofluoric acid solution. Vapor of the organic solvent is supplied after the wafer is lifted from the pure water within the rinsing bath.

The results indicates that when controlling the wafer lifting speed from the rinsing bath at 10 mm/sec, 5 mm/sec and 3 mm/sec, the number of increased defects is great. This is because beads of moisture remain in a longitudinal streak manner on the wafer, and watermarks are thereby generated during lifting the wafer.

The results also indicate that if the lifting speed is controlled at 2 mm/sec, the number of increased defects is reduced and there is no confirmation of the generation of unique minute defects.

As described, when the wafer having a hydrophobic surface is cleaned and dried with a single-bath type apparatus using organic solvent vapor, controlling the lifting speed at a finite value of 2 mm/sec or less enables restraint of the generation of minute defects in longitudinal manner from particles and/or watermarks.

In general, in a semiconductor fabrication process, even microscopic impurities or slight contaminants deposited onto a wafer during the process can cause failure. Therefore, it is important to prevent the generation of minute defects formed from particles and watermarks.

FIG. 3 shows a mechanism to prevent excess moisture from remaining in the vicinity of a wafer W by controlling the wafer lifting speed.

When the wafer W is lifted from the rinsing bath, the water surface in the rinsing bath is also lifted along the wafer W movement direction due to its surface tension. Gravity M, a shear force T due to the movement of the wafer W and the surface tension T of the moisture are applied to the moisture in the vicinity of the wafer W. The surface tension T1 is surface tension to be applied to the interface of pure water within the rinsing bath.

In the case of a hydrophilic wafer, a relationship, “Gravity M=Shear force τ+Surface tension T of moisture,” is established. In addition, the contact angle θ between the moisture and the wafer becomes an obtuse angle. Therefore, little lifted moisture remains on the wafer, by being dissociated from the water in the rinsing bath. However, in the case of a wafer having a hydrophobic surface, as shown in FIG. 3, the contact angle θ between the wafer W and moisture D is an acute angle, and the relationship, “Gravity M=Shear force τ+Surface tension T of moisture,” is easily established. As a result, the moisture D is separated as a minute bead from the water surface in the rinsing bath, and then remains on the wafer W. At this time, the shear force τ is represented by the following expression using viscosity μ and a distance from the wafer h, and it depends upon a wafer lifting speed u:

τ=μ×u/h

In other words, the control of the wafer lifting speed u enables the control of the shear force τ, and the establishment of the relationship, “Gravity M=Shear force τ+Surface tension T,” enables the prevention of excess moisture from remaining to be stilliform on the wafer. It is noted that moisture remaining on the wafer as an adhesion force is not considered.

The relational expression varies due to the surface state of the wafer. However, in a wafer having a surface in a complete hydrophobic state, the control of the lifting speed at a finite value, for example, between 0 mm/sec and 2 mm/sec, enables the restraint of minute defects formed from particles and/or watermarks. Similar results can be obtained in a wafer having a hydrophilic surface, or both a hydrophilic surface and a hydrophobic surface, as well.

Further, the controlled wafer lifting speed in the present embodiment is useful in a wafer having a surface in a complete hydrophobic state, and is also useful in a wafer substrate having a hydrophilic surface or a hydrophilic surface & a hydrophobic surface for restraining the generation of a minute defect group formed from particles and/or watermarks. Therefore, the speed for restraining moisture separation at the time of lifting the wafer having the surface in the complete hydrophobic state can be pre-set as the wafer lifting speed, and the lifting of the wafer can be controlled based on the pre-settings.

According to the present invention, in the cleaning and drying method with the single-bath type apparatus using an organic solvent, the above effect is caused just by a force applied to the pure water fluid in the vicinity of the wafer. Therefore, the similar efficacy can be obtained regardless of the wafer size and the type of liquid chemicals used for pre-process.

As described, the present invention is useful as the method for cleaning and drying a substrate with a single-bath type wet processing apparatus for a semiconductor substrate using an organic solvent.

This application is based on Japanese Patent Application No. 2006-231558 filed on Aug. 29, 2006, the entire contents of which are hereby incorporated by reference.

What is claimed is:

1. A method for cleaning and drying a substrate, comprising the steps of:
rinsing a surface of the substrate in a rinsing bath with pure water after wet processing of the substrate surface with liquid chemicals;
lifting the substrate from the rinsing bath at a speed determined in advance by making a substrate surface hydrophobic, after rinsing the substrate; and
removing moisture from the substrate surface by supplying an organic solvent to the substrate for a specified time, after lifting the substrate, the organic solvent being water soluble and lowering surface tension of the pure water.
